(19) United States
(12) Patent Application Publication
(10) Pub. No.: US 2026/0320180 A1
(43) Pub. Date: Oct. 15, 2026

(54) ADVERSARIAL IMAGE DETECTION SYSTEM USING SIMILARITY DIFFERENCES BETWEEN IMAGE AND CLASSIFIED LABEL

(71) Applicant: Foundation of Soongsil University-Industry Cooperation, Seoul (KR)

(72) Inventors: Daeseon Choi, Daejeon (KR); Sohee Park, Seoul (KR); Gwonsang Ryu, Suwon-si (KR)

(21) Appl. No.: 19/180,119

(22) Filed: Apr. 15, 2025

(51) Int. Cl. G06F 21/55; G06V 10/74; G06V 10/764; G06V 10/774; G06V 10/98; G06V 20/70

(52) U.S. Cl. CPC G06F 21/554; G06V 10/761; G06V 10/764; G06V 10/774; G06V 10/993; G06V 20/70; G06F 2221/033

(57) ABSTRACT

Disclosed is an adversarial image determining system including a text encoder that outputs a first text embedding vector, by using a first machine learning model, based on the first label being a classification result indicating an object included in the test target image, and outputs second text embedding vectors, by using the first machine learning model, based on the second labels being labels other than the first label among a plurality of predetermined labels, an image encoder that outputs an image embedding vector, which is an embedding vector corresponding to the test target image, based on the test target image by using a second machine learning model, and an adversarial image determining unit that determines whether the test target image is the adversarial perturbation image.

### BACKGROUND

Embodiments of the inventive concept described herein relate to an adversarial image determining system for determining whether an image is an adversarial perturbation image.

The inventive concept is derived from research conducted as part of Information Protection Core Source Technology Development (R&D) of the Ministry of Science and ICT (Project Unique No.: 1711193677, Project No.: 2021-0-00511-003, Research Project Name: Development of Robust AI and Distributed Attack Detection Technology for Edge AI Security, Project Management Agency: Information and Communications Technology Planning and Evaluation Institute, Research Period: 2023 Jan. 1 to 2023 Dec. 31). Meanwhile, there is no property interest of the Korean government in any aspect of the inventive concept.

An adversarial perturbation image refers to an image generated by adding human-imperceptible adversarial perturbations to an input image such that a deep neural network (DNN) for image classification mis-recognizes an original class as another class, and is sometimes referred to as an “adversarial example”. In the meantime, a deep learning model is vulnerable to an adversarial attack, which is an attack that allows the deep learning model to mis-classify the original class as another class by minimally perturbing the input image during inference.

Methods for detecting adversarial examples include 1) mitigating and removing adversarial perturbations in the input image, 2) adversarial training, which creates the deep learning model robust to adversarial attacks by training on adversarial examples, and 3) comparing and detecting the characteristic differences or statistical characteristics between normal images and adversarial examples.

In the case, 1) a method of mitigating or removing adversarial perturbation through conversion of the input image may mitigate the main features of a normal image because the conversion is performed on the normal image, and may not perform the classification correctly or may not completely remove the adversarial perturbation of an adversarial example that has not been trained during the training stage. Moreover, 2) in the case of adversarial training, it is necessary to separately generate adversarial examples for training, and defense effects on adversarial examples that have not been trained are reduced. 3) Most methods that use the difference between normal and adversarial examples require establishing a separate network.

### SUMMARY

Embodiments of the inventive concept provide an adversarial image determining system capable of accurately classifying adversarial examples compared to conventional general adversarial image determining methods.

Embodiments of the inventive concept provide an adversarial image determining system capable of maintaining the main features of an image by extracting and utilizing embeddings from input images and classified labels.

Embodiments of the inventive concept provide an adversarial image determining system that does not need to create a separate adversarial example.

Embodiments of the inventive concept provide an adversarial image determining system capable of being used to predict the detected adversarial example as the correct label because the similarity of a pair of an image and a correct label is high.

Embodiments of the inventive concept provide an adversarial image determining system capable of detecting adversarial examples without separately creating and training adversarial examples while an image is not affected because the input image is not processed through a series of processes.

Embodiments of the inventive concept provide an adversarial image determining system that reduces computational costs by performing training through fine-tuning faster and with less computational cost by using a pretrained encoder that has trained large-scale image and text data to detect adversarial examples even though there is a need for a separate encoder.

According to an exemplary embodiment, an adversarial image determining system includes an image receiving unit that receives a test target image, which is used to determine whether the test target image is an adversarial perturbation image created by adding noise to an original image, a text encoder that outputs a first text embedding vector, which is an embedding vector corresponding to a first label, by using a first machine learning model, based on the first label being a classification result indicating an object included in the test target image, and outputs second text embedding vectors, which are embedding vectors respectively corresponding to second labels, by using the first machine learning model, based on the second labels being labels other than the first label among a plurality of predetermined labels, an image encoder that outputs an image embedding vector, which is an embedding vector corresponding to the test target image, based on the test target image by using a second machine learning model, and an adversarial image determining unit that determines whether the test target image is the adversarial perturbation image, based on the first text embedding vector, the second text embedding vectors, and the image embedding vector.

Moreover, the adversarial image determining system may further include a classifier that outputs the first label corresponding to the test target image by using a third machine learning model based on the test target image.

Furthermore, the adversarial image determining unit may be configured to compute first cosine similarity, which is cosine similarity between the image embedding vector and the first text embedding vector, to compute second cosine similarity, which is cosine similarity between the image embedding vector and the second text embedding vector, with respect to each of the second text embedding vectors, and to determine the test target image as the adversarial perturbation image, when there are at least one piece or pieces of second cosine similarity, which are greater than the first cosine similarity, from among pieces of second cosine similarity respectively corresponding to the second text embedding vectors.

Also, the adversarial image determining system may further include a machine learning unit. The image receiving unit may be configured to receive a training-specific image in which a first training-specific label being a label indicating what object an image includes is set in advance. The machine learning unit may be configured to train the first machine learning model and the second machine learning model through a machine learning method based on the training-specific image and the first training-specific label.

Besides, the text encoder may be configured to output a first training-specific text embedding vector, which is an embedding vector corresponding to the first training-specific label, by using the first machine learning model based on the first training-specific label. The image encoder may be configured to output a training-specific image embedding vector, which is an embedding vector corresponding to the training-specific image, by using the second machine learning model based on the training-specific image.

In addition, the machine learning unit may be configured to compute first training-specific cosine similarity, which is cosine similarity between the training-specific image embedding vector and the first training-specific text embedding vector, and to train the first machine learning model and the second machine learning model such that the first training-specific cosine similarity increases while training is repeated.

Moreover, the text encoder may be configured to output second training-specific text embedding vectors, which are embedding vectors respectively corresponding to second training-specific labels, by using the first machine learning model based on the second training-specific labels, which are labels other than the first training-specific label among a plurality of predetermined labels. The machine learning unit may be configured to compute second training-specific cosine similarity, which is cosine similarity between the training-specific image embedding vector and the second training-specific text embedding vector, and to train the first machine learning model and the second machine learning model such that the second training-specific cosine similarity decreases while training is repeated.

According to an exemplary embodiment, an operating method of an adversarial image determining system includes receiving, by an image receiving unit, a test target image, which is used to determine whether the test target image is an adversarial perturbation image created by adding noise to an original image, outputting, by a classifier, a first label, which is a classification result indicating an object included in the test target image and which corresponds to the test target image, based on the test target image by using a third machine learning model, outputting, by a text encoder, a first text embedding vector, which is an embedding vector corresponding to the first label, by using a first machine learning model based on the first label, outputting, by the text encoder, second text embedding vectors, which are embedding vectors respectively corresponding to second labels, by using the first machine learning model based on the second labels, which are labels other than the first label among a plurality of predetermined labels, outputting, by an image encoder, an image embedding vector, which is an embedding vector corresponding to the test target image, based on the test target image by using a second machine learning model, and determining, by an adversarial image determining unit, whether the test target image is an adversarial perturbation image, based on the first text embedding vector, the second text embedding vectors, and the image embedding vector. The determining of whether the test target image is the adversarial perturbation image includes computing, by the adversarial image determining unit, first cosine similarity, which is cosine similarity between the image embedding vector and the first text embedding vector, computing, by the adversarial image determining unit, second cosine similarity, which is cosine similarity between the image embedding vector and the second text embedding vector, with respect to each of the second text embedding vectors, and determining, by the adversarial image determining unit, the test target image as the adversarial perturbation image, when there are at least one piece or pieces of second cosine similarity, which are greater than the first cosine similarity, from among pieces of second cosine similarity respectively corresponding to the second text embedding vectors.

Furthermore, the operating method may further include receiving, by the image receiving unit, a training-specific image in which a first training-specific label being a label indicating what object an image includes is set in advance, outputting, by the text encoder, a first training-specific text embedding vector, which is an embedding vector corresponding to the first training-specific label, by using the first machine learning model based on the first training-specific label, outputting, by the image encoder, a training-specific image embedding vector, which is an embedding vector corresponding to the training-specific image, by using the second machine learning model based on the training-specific image, and training, by a machine learning unit, the first machine learning model and the second machine learning model through a machine learning method based on the training-specific image and the first training-specific label. The training of the first machine learning model and the second machine learning model may include computing, by the machine learning unit, first training-specific cosine similarity, which is cosine similarity between the training-specific image embedding vector and the first training-specific text embedding vector, and training, by the machine learning unit, the first machine learning model and the second machine learning model such that the first training-specific cosine similarity increases while training is repeated.

According to an exemplary embodiment, a non-transitory recording medium stores a computer-readable computer program to execute the control method of the adversarial image determining system.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of an adversarial image determining system, according to an embodiment;

FIG. 2 is a diagram for describing a method for determining an adversarial image, according to an embodiment;

FIG. 3 is a diagram for describing a method for training a machine learning model, according to an embodiment;

FIG. 4 is a diagram for describing a process of training a machine learning model through a text encoder and an image encoder, according to an embodiment;

FIG. 5 is a diagram illustrating outputting an embedding vector through a text encoder and an image encoder after machine learning is completed, according to an embodiment;

FIG. 6 is a flowchart of an adversarial image determining method, according to an embodiment;

FIG. 7 is a flowchart of a method for training a machine learning model used to determine an adversarial image, according to an embodiment; and

FIG. 8 is a graph showing the performance of an adversarial image determining method, according to an embodiment.

### DETAILED DESCRIPTION

The same reference numerals denote the same elements throughout the specification. This specification does not describe all elements of embodiments. Well-known content or redundant content in which embodiments are the same as one another will be omitted in a technical field to which the inventive concept belongs. A term such as ‘unit’ used in the specification may be implemented with software or hardware. According to embodiments, a plurality of ‘units’ may be implemented with one component, or a single ‘unit’may include a plurality of components.

Furthermore, when a portion “comprises” a component, it will be understood that it may further include another component, without excluding other components unless specifically stated otherwise. Terms such as ‘first’, ‘second’, and the like are used to distinguish one component from another component, and thus the component is not limited by the terms described above. Unless there are obvious exceptions in the context, a singular form includes a plural form.

In each step, an identification code is used for convenience of description. The identification code does not describe the order of each step. Unless the context clearly states a specific order, each step may be performed differently from the specified order. Hereinafter, operating principles and embodiments of the inventive concept will be described with reference to the accompanying drawings.

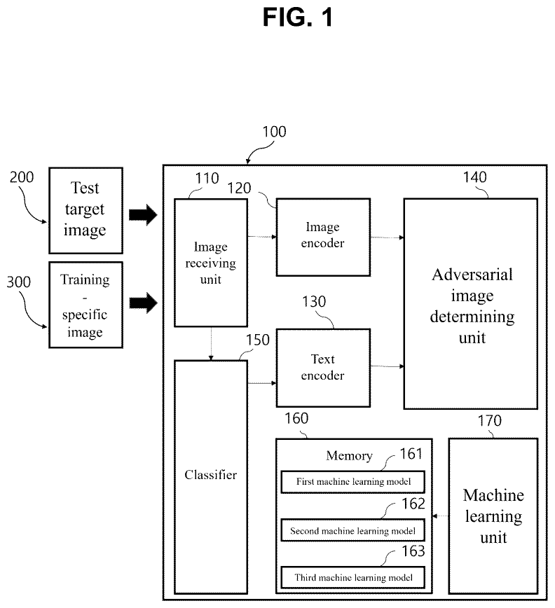

FIG. 1 is a block diagram of an adversarial image determining system, according to an embodiment.

Referring to FIG. 1, an adversarial image determining system 100 according to an embodiment of the inventive concept may include an image receiving unit 110, an image encoder 120, a text encoder 130, an adversarial image determining unit 140, a classifier 150, a memory 160, and a machine learning unit 170.

The adversarial image determining system 100 may be a system that determines whether a received image is an adversarial perturbation image, or a system configured to train a machine learning model used to determine whether the received image is an adversarial perturbation image. The adversarial image determining system 100 according to an embodiment of the inventive concept may be a system provided on an image classification device provided separately, or may be a system provided on a server.

An adversarial perturbation image or an adversarial image may be an image created by adding adversarial perturbation that is not recognizable by humans to an input image such that a deep neural network for image classification mis-classifies an original class as another class.

The image receiving unit 110 may receive a test target image 200. The test target image 200 may be an image, which is used to determine whether the image is an adversarial perturbation image created by adding noise to the original image, not an adversarial perturbation image. In other words, the test target image 200 may be an image that the user actually wants to classify after the training stage of a machine learning model of the adversarial image determining system 100.

The fact that the image receiving unit 110 receives images may be receiving images from an input terminal in a method of receiving the images, which are entered by a user through the input terminal, but is not limited thereto. For example, the image receiving unit 110 may receive the test target image 200 and a training-specific image 300 in a method of receiving images that have been previously stored in the memory 160, or images received from a server by a communication unit included in the adversarial image determining system 100. The image receiving unit 110 may deliver the received test target image 200 and the received training-specific image 300 to the image encoder 120 and the classifier 150.

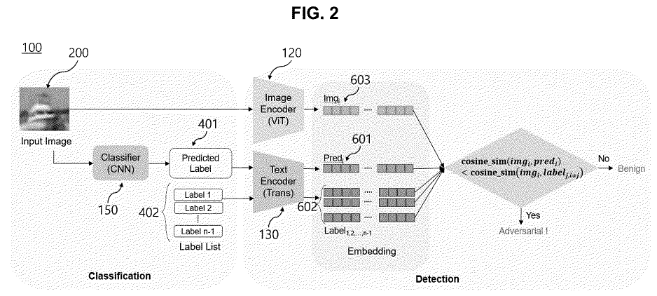

FIG. 2 is a diagram for describing a method for determining an adversarial image, according to an embodiment.

Referring to FIGS. 1 and 2, the classifier 150 may output a first label 401 corresponding to the test target image 200 by using a third machine learning model 163 based on the test target image 200. The first label 401 may be the classification result, which is output by the classifier 150 and which indicates an object included in the test target image 200.

For example, when the test target image 200 including a boat image is a normal image, not an adversarial perturbation image, the classifier 150 may output the first label 401, which means that the label corresponding to the test target image 200 is a ‘boat’.

The deep learning-based image classification technology used by the classifier 150 according to an embodiment may be a technology for classifying an image by using the third machine learning model 163 that is trained in advance based on data of features extracted from the image. In this case, the structure of convolutional neural networks (CNN) having multiple convolution layers may be used to train a method of extracting features from images, but the method of extracting features from images is not limited thereto.

The third machine learning model 163 based on CNN may classify image labels well with respect to normal images, but may perform incorrect labeling on adversarial perturbation images. For example, when the test target image 200 including a boat image is an adversarial perturbation image, the classifier 150 may output the first label 401, which means that the label corresponding to the test target image 200 is a ‘cat’.

The classifier 150 may deliver the first label 401 to the text encoder 130. The text encoder 130 may output a first text embedding vector 601 by using a first machine learning model 161 based on the first label 401. The first text embedding vector 601 may be an embedding vector corresponding to the first label 401. The first machine learning model 161 may be a model pretrained to output an embedding vector corresponding to the corresponding label based on the input label.

A second label 402 may be labels, not the first label 401, from among a plurality of predetermined labels. For example, when the plurality of predetermined labels are a ‘boat’, a ‘car’, a ‘cat’, and a ‘dog’, and the first label 401 output by the classifier 150 is the ‘boat’, the second labels 402 may be the ‘car’, the ‘cat’, and the ‘dog’.

The text encoder 130 may output second text embedding vectors 602 by using the first machine learning model 161 based on the second labels 402. The second text embedding vector 602 may be an embedding vector corresponding to each of the second labels 402. The text encoder 130 may deliver the first text embedding vector 601 and the second text embedding vector 602 to the adversarial image determining unit 140.

The image encoder 120 may output an image embedding vector 603, which is an embedding vector corresponding to the test target image 200, by using a second machine learning model 162 based on the test target image 200. The second machine learning model 162 may be a model pretrained to output an embedding vector corresponding to the corresponding image based on the input image. The image encoder 120 may deliver the image embedding vector 603 to the adversarial image determining unit 140.

The adversarial image determining unit 140 may determine whether the test target image 200 is an adversarial perturbation image, based on the first text embedding vector 601, the second text embedding vectors 602, and the image embedding vector 603.

For example, when the test target image 200 is a normal image, the classifier 150 may output a label suitable for the test target image 200 as the first label 401. In this case, the first text embedding vector 601, which is the embedding vector for the first label 401, may be most similar to the image embedding vector 603 among the second text embedding vectors 602, which are the embedding vectors for the second labels 402. On the other hand, when the test target image 200 is an adversarial perturbation image, the classifier 150 may output a label, which is not suitable for the test target image 200, as the first label 401. In this case, the second text embedding vector 602, which is an embedding vector of the second label 402 that corresponds more appropriately to an image from among the second labels 402 than the first text embedding vector 601 being the embedding vector for the first label 401, may be similar to the image embedding vector 603. The adversarial image determining unit 140 may determine whether the test target image 200 is an adversarial perturbation image, through the similarity between these embedding vectors.

In detail, the adversarial image determining unit 140 may compute the first cosine similarity. The first cosine similarity may be the cosine similarity between the image embedding vector 603 and the first text embedding vector 601.

Moreover, the adversarial image determining unit 140 may compute second cosine similarity for each of the second text embedding vectors 602. The second cosine similarity may be the cosine similarity between the image embedding vector 603 and the second text embedding vector 602.

When there are at least one piece or pieces of second cosine similarity, which are greater than the first cosine similarity, from among pieces of second cosine similarity respectively corresponding to the second text embedding vectors 602, the adversarial image determining unit 140 may determine the test target image 200 as an adversarial perturbation image.

On the other hand, when there is no second cosine similarity that is greater than the first cosine similarity among the pieces of second cosine similarity respectively corresponding to the second text embedding vectors 602, the adversarial image determining unit 140 may determine the test target image 200 as a normal image.

In the meantime, to perform the above-described test stage, it is desirable to appropriately train machine learning models in advance.

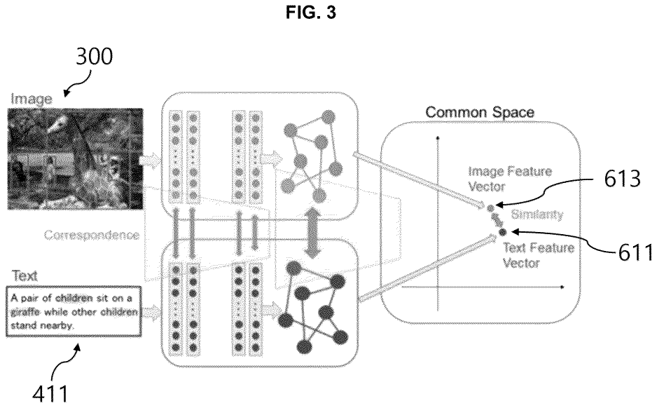

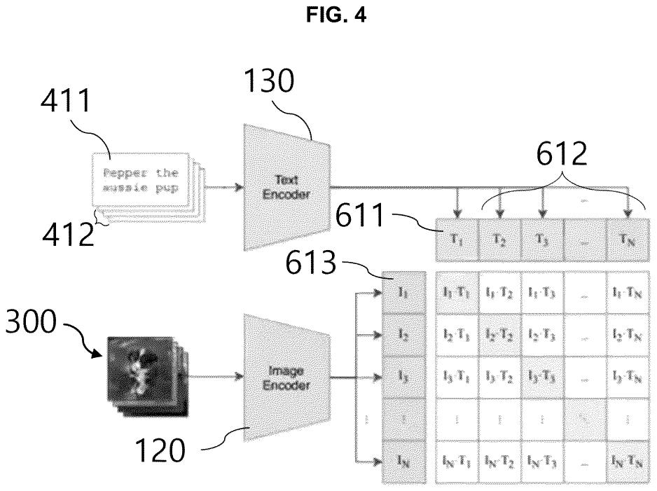

FIG. 3 is a diagram for describing a method for training a machine learning model, according to an embodiment. FIG. 4 is a diagram for describing a process of training a machine learning model through the text encoder 130 and the image encoder 120, according to an embodiment.

Referring to FIGS. 1, 3, and 4, the image receiving unit 110 may receive the training-specific image 300. The image receiving unit 110 may deliver the training-specific image 300 to the machine learning unit 170.

The training-specific images 300 may be the plurality of training-specific images 300 used for training the first machine learning model 161 and the second machine learning model 162. Each of the training-specific images 300 may be a predetermined image for which a first training-specific label 411 is set. The first training-specific label 411 may be a label indicating an object included in the image. For example, when the training-specific image 300 is an image including a giraffe image, the first training-specific label 411 corresponding thereto may be a ‘giraffe’. In the meantime, the first training-specific label 411 is not necessarily limited to a single word indicating an object as described above, and may be a sentence for describing the state of the object. For example, the first training-specific label 411 corresponding to the training-specific image 300 being an image of a giraffe surrounded by children may be ‘giraffe near children’.

The machine learning unit 170 may train the first machine learning model 161 and the second machine learning model 162 through a machine learning method based on the training-specific image 300 and the first training-specific label 411. The machine learning unit 170 may train the first machine learning model 161 and the second machine learning model 162 through repetitive machine learning. The first machine learning model 161 and the second machine learning model 162 that are being trained may be stored in the memory 160.

The machine learning may use a model composed of a plurality of parameters and may mean optimizing parameters with given data. The machine learning may include supervised learning, unsupervised learning, and reinforcement learning depending on the type of learning problem. The supervised learning may refer to learning a mapping between inputs and outputs, and may be applied when pairs of inputs and outputs are given as data. The unsupervised learning may be applied when there is only input and no output, and may find regularities between inputs. However, the machine learning according to an embodiment is not necessarily limited to the learning method described above.

The first machine learning model 161 may be a transformer-based deep learning model. A transformer-based deep learning model may be a very effective model for natural language processing (NLP) and other sequence data processing tasks. The transformer-based deep learning model may be used in various NLP tasks such as machine translation, text classification, question answering, summarization, conversation models, and generative models. The transformer-based deep learning model may be used to model context and process sequence data more effectively than NLP models based on conventional recurrent neural networks (RNNs) and conventional convolutional neural networks (CNNs).

The second machine learning model 162 may be a Vision Transformer (ViT)-based deep learning model. The ViT-based model may be a modified transformer model developed for computer vision tasks. The ViT-based model may be a model utilized for vision tasks such as image classification, object detection, and segmentation, and may be a deep learning model that divides an image into patches and provides the patches as an input to transformer architecture, instead of directly using a pixel value of the image as an input.

The ViT-based model may divide an input image into grid-shaped patches in the image patch segmentation stage, and each patch may be used as an input to the transformer model. This may be a method of converting an image into a series of vectors and applying image information to a transformer that processes sequence data such as text. After the ViT-based model is pretrained on a large-scale vision data set in pretrain and fine-tuning stages, it may be finely tuned to be suitable for a specific vision task, and thus may effectively train representations for image-related tasks. In a self-attention stage, the ViT-based model may model the relationship between the patches of the image by utilizing the self-attention mechanism of a transformer. In a class prediction stage, the ViT-based model may usually end with a Multi-Layer Perceptron (MLP) layer of a rear part for the classification task, and may perform class label prediction for each image. The vision transformer may have excellent performance in image classification and vision tasks, and may be models with excellent ability to detect long-range dependencies, especially compared to conventional convolutional neural networks (CNNs).

Referring to FIG. 4, the text encoder 130 may output a first training-specific text embedding vector 611 by using the first machine learning model 161 based on the first training-specific label 411. The first training-specific text embedding vector 611 may be the embedding vector corresponding to the first training-specific label 411. For example, the text encoder 130 may receive the first training-specific label 411 indicating a ‘puppy’, and may output the first training-specific text embedding vector T1 611. The text encoder 130 may deliver the first training-specific text embedding vector 611 to the machine learning unit 170.

The image encoder 120 may output a training-specific image embedding vector 613 by using the second machine learning model 162 based on the training-specific image 300. The training-specific image embedding vector 613 may be an embedding vector corresponding to the training-specific image 300. For example, the image encoder 120 may receive the training-specific image 300 including a puppy image and may output the training-specific image embedding vector I1 613 corresponding to the training-specific image 300. The image encoder 120 may deliver the training-specific image embedding vector 613 to the machine learning unit 170.

The machine learning unit 170 may compute first training-specific cosine similarity I1-T1, which is the cosine similarity between the training-specific image embedding vector I1 613 and the first training-specific text embedding vector T1 611. The machine learning unit 170 may train the first machine learning model 161 and the second machine learning model 162 such that the first training-specific cosine similarity increase while the training is repeated.

In the meantime, the training of the first machine learning model 161 and the second machine learning model 162 may correspond to a method of utilizing not only the first training-specific label 411 but also a second training-specific label 412, which is a label other than the first training-specific label 411 among a plurality of predetermined labels.

The text encoder 130 may output second training-specific text embedding vectors 612 by using the first machine learning model 161 based on the second training-specific labels 412. The second training-specific text embedding vector 612 may be an embedding vector corresponding to each of the second training-specific labels 412. For example, the text encoder 130 may receive the second training-specific labels 412 such as a ‘boat’, a ‘car’, and a ‘cat’ with respect to a puppy image, and may output the second training-specific text embedding vectors T2, T3, . . . , Ts 612. The text encoder 130 may deliver the second training-specific text embedding vector 612 to the machine learning unit 170.

The machine learning unit 170 may compute the second training-specific cosine similarity I1-T2, I1-T3, . . . , I1-Ts, which is the cosine similarity between the training-specific image embedding vector I1 613 and the second training-specific text embedding vectors T2, T3, . . . , Ts 612.

The machine learning unit 170 may train the first machine learning model 161 and the second machine learning model 162 such that the second training-specific cosine similarity I1-T2, I1-T3, . . . , I1-Ts decreases while the training is repeated. After the repeated machine learning is completed, the adversarial image determining system 100 may perform image classification on the test target image 200.

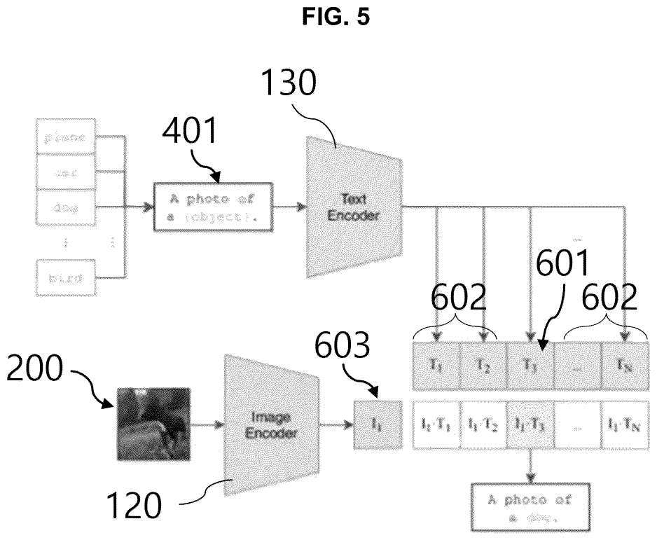

FIG. 5 is a diagram illustrating outputting an embedding vector through a text encoder and the image encoder 120 after machine learning is completed, according to an embodiment.

Referring to FIG. 5, it may be seen that the text encoder 130 using the first machine learning model 161, which is a transformer model, outputs a first text embedding vector T3 601 based on the first label 401, and the image encoder 120 using the second machine learning model 162, which is a vision transformer model, outputs an image embedding vector I1 603 based on the test target image 200.

In this case, the adversarial image determining unit 140 may determine whether the test target image 200 is an adversarial perturbation image, by comparing the cosine similarity I1-T3 between the first text embedding vector T3 601 and the image embedding vector I1 603 with the pieces of cosine similarity I1-T1, I1-T2, . . . , I1-Ts between the image embedding vector I1 603 and the second text embedding vectors T1, T2, . . . , Ts 602.

The text encoder 130 using the transformer model may perform natural language processing (NLP) tasks. The text encoder 130, which uses a transformer model, may process given text data and may convert the processed result into a usable format.

In an input embedding stage, the text encoder 130 may perform embedding on an input text, and the embedding may be performed at word, sentence, or token levels. In this case, each token may be converted into a fixed dimensional vector by mainly using a word embedding scheme, and the text data may be expressed in a format capable of being processed by the model. In a positional encoding stage, the transformer model may use positional encoding to encode word order information, and may add a vector indicating a relative position of a word such that the model is capable of understanding the order of the word. In a self-attention stage, the text encoder 130 may allow each word or token to model a relationship with all other words, may identity contexts in this way, and may better understand text in consideration of the interactions between words. In a multi-head attention stage, the encoder may compute and combine attention from several different perspectives such that the model is capable of detecting various features and relationships. In an encoder layer stack stage, the text encoder 130 may be composed of a plurality of encoder layers. In the case, each layer may include embedding, positional encoding, attention mechanism, and output to the next layer, and the model may increasingly train complex contexts through these multiple layers. That is, the text encoder 130 may convert an input text into an internal representation capable of being processed by the transformer model, may help to capture the meaning and contextual information of the text more largely, and may be utilized for various NLP tasks.

A ViT-based encoder may convert an input image into a form capable of being processed by the transformer model. Transformer architecture may be mainly used to process sequence data. In an image patch embedding stage, the vision transformer model may divide the input image into grid-shaped patches, may perform embedding on each patch, and may convert the embedded result into a vector obtained by digitizing image information. Patch embeddings converted in this way may be considered as the sequence data. In the positional encoding stage, because the patch embedding does not reflect spatial information, the vision transformer model may provide location information for each patch by adding positional encoding. In the self-attention stage, the encoder may use the patch embedding as the input to the self-attention mechanism of the transformer. In this way, the vision transformer model models the interaction between patches and may identify long-range dependency within an image. In the multi-head attention stage, the vision transformer model may compute attention from a plurality of viewpoints by using the multi-head attention mechanism. In a Multi-Layer Perceptron (MLP) layer stage, after the attention, information obtained by modeling the relationship between patches may be delivered to the MLP layer to convert the representation. In a class prediction stage, the encoder of the vision transformer model may perform class prediction on an image through an output layer for classification.

At least one component may be added or deleted to correspond to the performance of the components described above. Furthermore, it will be easily understood by those skilled in the art that mutual locations of the components may be changed to correspond to the performance or structure of the system.

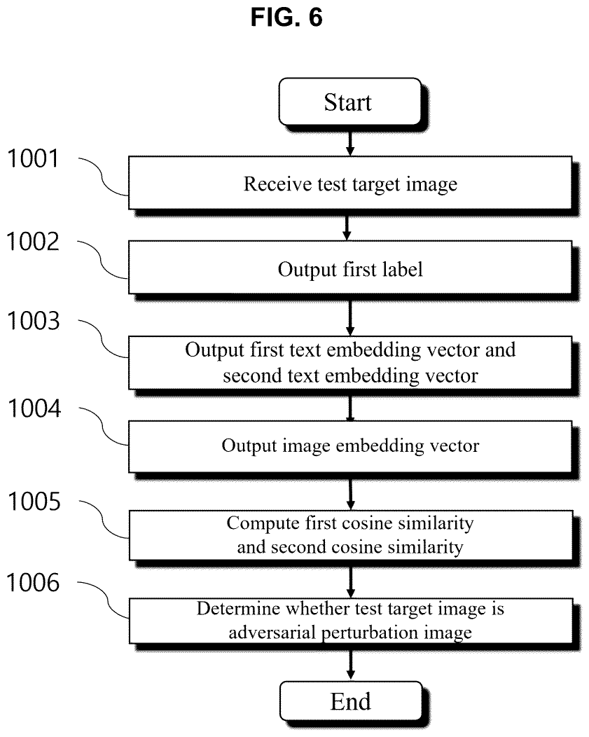

FIG. 6 is a flowchart of an adversarial image determining method, according to an embodiment. This is only a preferred embodiment for achieving the purpose of the inventive concept, and it is obvious that some configurations may be added or deleted as necessary.

Referring to FIG. 6, the image receiving unit 110 may receive the test target image 200, which is used to determine whether the test target image 200 is an adversarial perturbation image generated by adding noise to an original image (1001).

The classifier 150 may output the first label 401, which is the classification result indicating an object included in the test target image 200 and which corresponds to the test target image 200, based on the test target image 200 by using the third machine learning model 163 (1002).

The text encoder 130 may output the first text embedding vector 601, which is an embedding vector corresponding to the first label 401 by using the first machine learning model 161 based on the first label 401, and may output the second text embedding vectors 602, which are embedding vectors respectively corresponding to the second labels 402, based on the second labels 402, which are labels other than the first label 401 among the predetermined multiple labels by using the first machine learning model 161 (1003).

The image encoder 120 may output the image embedding vector 603, which is an embedding vector corresponding to the test target image 200, by using the second machine learning model 162 based on the test target image 200 (1004).

The adversarial image determining unit 140 may compute first cosine similarity, which is cosine similarity between the image embedding vector 603 and the first text embedding vector 601, and may compute second cosine similarity, which is cosine similarity between the image embedding vector 603 and the second text embedding vector 602, with respect to each of the second text embedding vectors 602 (1005).

When there are at least one piece or pieces of second cosine similarity, which are greater than the first cosine similarity, from among pieces of second cosine similarity respectively corresponding to the second text embedding vectors 602, the adversarial image determining unit 140 may determine the test target image 200 as an adversarial perturbation image (1006).

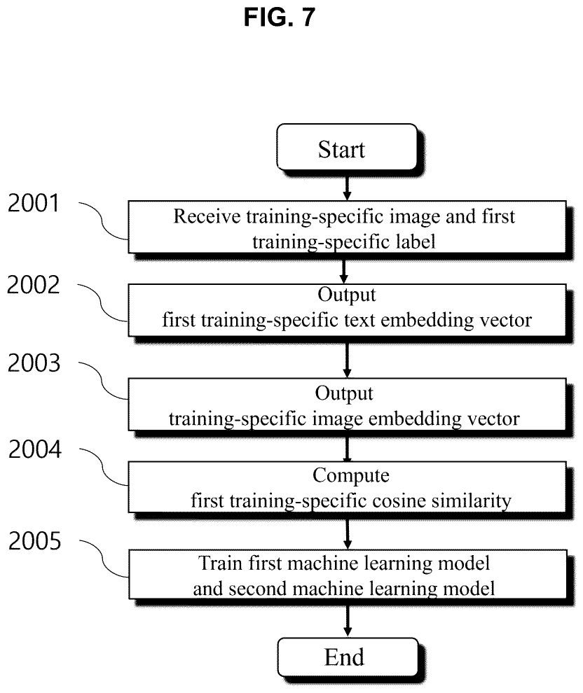

FIG. 7 is a flowchart of a method for training a machine learning model used to determine an adversarial image, according to an embodiment.

Referring to FIG. 7, the image receiving unit 110 may receive the first training-specific label 411, which is a label indicating an object included in an image, and the training-specific image 300 in which the first training-specific label 411 is set in advance (2001).

The text encoder 130 may output the first training-specific text embedding vector 611, which is an embedding vector corresponding to the first training-specific label 411, by using the first machine learning model 161 based on the first training-specific label 411 (2002).

The image encoder 120 may output the training-specific image embedding vector 613, which is an embedding vector corresponding to the training-specific image 300, based on the training-specific image 300 by using the second machine learning model 162 (2003).

The machine learning unit 170 may compute first training-specific cosine similarity, which is the cosine similarity between the training-specific image embedding vector 613 and the first training-specific text embedding vector 611 (2004).

The machine learning unit 170 may train the first machine learning model 161 and the second machine learning model 162 such that the first training-specific cosine similarity increase while the training is repeated (2005).

Each of the image receiving unit 110, the image encoder 120, the text encoder 130, the adversarial image determining unit 140, the classifier 150, the memory 160, and the machine learning unit 170 may be one of a plurality of processors included in the adversarial image determining system 100. In addition, the adversarial training method according to an embodiment of the inventive concept described so far may be implemented in a form of a program capable of being driven by a processor.

Here, the program may include program instructions, data files, data structures, etc. independently or may include a combination thereof. The program may be designed and produced by using machine codes or high-level language codes. The program may be specially designed to implement the above-described method for determining an adversarial image, or may be implemented by using various functions or definitions known and available to those skilled in the art in a computer software field. The program for implementing the above-described method for determining an adversarial image may be recorded on a non-transitory recording medium readable by a processor. In this case, the recording medium may be the memory 160.

The memory 160 may store a program that performs the operations described above and operations described later, and the processor may execute the stored program stored in the memory 160. When there are a plurality of processors and the plurality of memories 160, they may be integrated into one chip, or they may be provided at physically separate locations. The memory 160 may include a volatile memory such as a static random access memory (SRAM) and a dynamic random access memory (DRAM) for temporarily storing data. Moreover, the memory 160 may include a nonvolatile memory such as a read only memory (ROM), an erasable programmable read only memory (EPROM), and an electrically erasable programmable read only memory (EEPROM) for long-term storage of control programs and control data. The processor may include various logic circuits and arithmetic circuits, may process data depending on the program provided from the memory 160, and may generate control signals depending on the processed result.

To verify the performance of the adversarial image determining system 100 according to an embodiment of the inventive concept, an experiment has been conducted to determine an adversarial perturbation image.

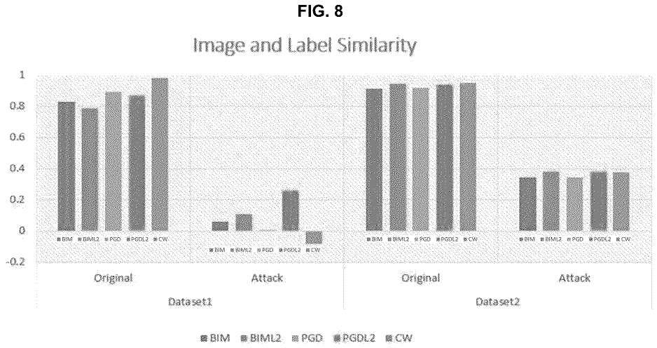

FIG. 8 is a graph showing the performance of an adversarial image determining method, according to an embodiment.

Referring to FIG. 8, it may be seen that the adversarial image determining method according to an embodiment has more excellent performance in determining whether an image is adversarial than various adversarial attack methods BIM, BIML2, PGD, PGDL2, and CW.

In detail, the shown graph indicates the similarity between an adversarial example and a label. “Original” indicates the similarity between the adversarial example and a correct answer. “Attack” indicates the similarity between the adversarial example and an attacked label (misclassified label). In this case, it may be seen that the similarity with the correct answer is greater than that of the attacked label despite an adversarial example.

Disclosed embodiments are described above with reference to the accompanying drawings. One ordinary skilled in the art to which the inventive concept belongs will understand that the inventive concept may be practiced in forms other than the disclosed embodiments without altering the technical ideas or essential features of the inventive concept. The disclosed embodiments are examples and should not be construed as limited thereto.

According to one aspect of the disclosed inventive concept, it is possible to accurately classify adversarial examples compared to conventional general adversarial image determining methods.

Moreover, according to an embodiment of the inventive concept, it is possible to maintain the main features of an image by extracting and utilizing embeddings from input images and classified labels.

Furthermore, according to an embodiment of the inventive concept, it is not necessary to create a separate adversarial example.

Also, according to an embodiment of the inventive concept, it is possible to predict the detected adversarial example as the correct label because the similarity of a pair of an image and a correct label is high.

In addition, according to an embodiment of the inventive concept, it is possible to detect adversarial examples without separately creating and training adversarial examples while an image is not affected because the input image is not processed through a series of processes.

Moreover, according to an embodiment of the inventive concept, it is possible to reduce computational costs by performing training through fine-tuning faster and with less computational cost by using a pretrained encoder that has trained large-scale image and text data to detect adversarial examples even though there is a need for a separate encoder.

Besides, according to an embodiment of the inventive concept, performance such as an increase in data processing speed or a decrease in required memory capacity may be improved compared to a conventional system.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An adversarial image determining system, the system comprising:
an image receiving unit configured to receive a test target image, which is used to determine whether the test target image is an adversarial perturbation image created by adding noise to an original image;
a text encoder configured to output a first text embedding vector, which is an embedding vector corresponding to a first label, by using a first machine learning model, based on the first label being a classification result indicating an object included in the test target image, and to output second text embedding vectors, which are embedding vectors respectively corresponding to second labels, by using the first machine learning model, based on the second labels being labels other than the first label among a plurality of predetermined labels;
an image encoder configured to output an image embedding vector, which is an embedding vector corresponding to the test target image, based on the test target image by using a second machine learning model; and
an adversarial image determining unit configured to determine whether the test target image is the adversarial perturbation image, based on the first text embedding vector, the second text embedding vectors, and the image embedding vector.

2. The system of claim 1, further comprising:
a classifier configured to output the first label corresponding to the test target image by using a third machine learning model based on the test target image.

3. The system of claim 1, wherein the adversarial image determining unit is configured to:
compute first cosine similarity, which is cosine similarity between the image embedding vector and the first text embedding vector;
compute second cosine similarity, which is cosine similarity between the image embedding vector and the second text embedding vector, with respect to each of the second text embedding vectors; and
determine the test target image as the adversarial perturbation image, when there are at least one piece or pieces of second cosine similarity, which are greater than the first cosine similarity, from among pieces of second cosine similarity respectively corresponding to the second text embedding vectors.

4. The system of claim 3, further comprising:
a machine learning unit,
wherein the image receiving unit is configured to:
receive a training-specific image in which a first training-specific label being a label indicating what object an image includes is set in advance, and
wherein the machine learning unit is configured to:
train the first machine learning model and the second machine learning model through a machine learning method based on the training-specific image and the first training-specific label.

5. The system of claim 4, wherein the text encoder is configured to:
output a first training-specific text embedding vector, which is an embedding vector corresponding to the first training-specific label, by using the first machine learning model based on the first training-specific label, and
wherein the image encoder is configured to:
output a training-specific image embedding vector, which is an embedding vector corresponding to the training-specific image, by using the second machine learning model based on the training-specific image.

6. The system of claim 5, wherein the machine learning unit is configured to:
compute first training-specific cosine similarity, which is cosine similarity between the training-specific image embedding vector and the first training-specific text embedding vector; and
train the first machine learning model and the second machine learning model such that the first training-specific cosine similarity increases while training is repeated.

7. The system of claim 6, wherein the text encoder is configured to:
output second training-specific text embedding vectors, which are embedding vectors respectively corresponding to second training-specific labels, by using the first machine learning model based on the second training-specific labels, which are labels other than the first training-specific label among the plurality of predetermined labels, and
wherein the machine learning unit is configured to:
compute second training-specific cosine similarity, which is cosine similarity between the training-specific image embedding vector and the second training-specific text embedding vector; and
train the first machine learning model and the second machine learning model such that the second training-specific cosine similarity decreases while training is repeated.

8. An operating method of an adversarial image determining system, the method comprising:
receiving, by an image receiving unit, a test target image, which is used to determine whether the test target image is an adversarial perturbation image created by adding noise to an original image;
outputting, by a classifier, a first label, which is a classification result indicating an object included in the test target image and which corresponds to the test target image, based on the test target image by using a third machine learning model;
outputting, by a text encoder, a first text embedding vector, which is an embedding vector corresponding to the first label, by using a first machine learning model based on the first label;
outputting, by the text encoder, second text embedding vectors, which are embedding vectors respectively corresponding to second labels, by using the first machine learning model based on the second labels, which are labels other than the first label among a plurality of predetermined labels;
outputting, by an image encoder, an image embedding vector, which is an embedding vector corresponding to the test target image, based on the test target image by using a second machine learning model; and
determining, by an adversarial image determining unit, whether the test target image is an adversarial perturbation image, based on the first text embedding vector, the second text embedding vectors, and the image embedding vector,
wherein the determining of whether the test target image is the adversarial perturbation image includes:
computing, by the adversarial image determining unit, first cosine similarity, which is cosine similarity between the image embedding vector and the first text embedding vector;
computing, by the adversarial image determining unit, second cosine similarity, which is cosine similarity between the image embedding vector and the second text embedding vector, with respect to each of the second text embedding vectors; and
determining, by the adversarial image determining unit, the test target image as the adversarial perturbation image, when there are at least one piece or pieces of second cosine similarity, which are greater than the first cosine similarity, from among pieces of second cosine similarity respectively corresponding to the second text embedding vectors.

9. The method of claim 8, further comprising:
receiving, by the image receiving unit, a training-specific image in which a first training-specific label being a label indicating what object an image includes is set in advance;
outputting, by the text encoder, a first training-specific text embedding vector, which is an embedding vector corresponding to the first training-specific label, by using the first machine learning model based on the first training-specific label;
outputting, by the image encoder, a training-specific image embedding vector, which is an embedding vector corresponding to the training-specific image, by using the second machine learning model based on the training-specific image; and
training, by a machine learning unit, the first machine learning model and the second machine learning model through a machine learning method based on the training-specific image and the first training-specific label,
wherein the training of the first machine learning model and the second machine learning model includes:
computing, by the machine learning unit, first training-specific cosine similarity, which is cosine similarity between the training-specific image embedding vector and the first training-specific text embedding vector; and
training, by the machine learning unit, the first machine learning model and the second machine learning model such that the first training-specific cosine similarity increases while training is repeated.

10. A non-transitory computer-readable recording medium storing a computer program to execute the control method of the adversarial image determining system of claim 8.
